(19) United States
(12) Patent Application Publication
(10) Pub. No.: US 2004/0181815 A1
(43) Pub. Date: Sep. 16, 2004

(54) Printer with radio or television program extraction and formating

(76) Inventors: Jonathan J. Hull, San Carlos, CA (US); Jamey Graham, San Jose, CA (US); Peter E. Hart, Menlo Park, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/814,702

(22) Filed: Mar. 30, 2004

Related U.S. Application Data
(63) Continuation-in-part of application No. 10/081,129, filed on Feb. 21, 2002.
(63) Continuation-in-part of application No. 10/001,895, filed on Nov. 19, 2001.
(63) Continuation-in-part of application No. 10/001,849, filed on Nov. 19, 2001.
(63) Continuation-in-part of application No. 10/001,893, filed on Nov. 19, 2001.
(63) Continuation-in-part of application No. 10/001,894, filed on Nov. 19, 2001.
(63) Continuation-in-part of application No. 10/001,891, filed on Nov. 19, 2001.
(63) Continuation-in-part of application No. 10/175,540, filed on Jun. 18, 2002.
(63) Continuation-in-part of application No. 10/645,821, filed on Aug. 20, 2003.
(63) Continuation-in-part of application No. 10/081,129, filed on Feb. 21, 2002.
(63) Continuation-in-part of application No. 10/701,966, filed on Nov. 4, 2003.
(63) Continuation-in-part of application No. 10/465,027, filed on Jun. 18, 2003.
(63) Continuation-in-part of application No. 10/174,522, filed on Jun. 17, 2002.
(60) Provisional application No. 60/506,303, filed on Sep. 25, 2003.
(60) Provisional application No. 60/506,302, filed on Sep. 25, 2003.

(51) Int. Cl. H04N 7/173; G10L 15/04; G10L 17/00; G10L 15/00; H04N 5/445; G06F 3/00; H04H 9/00; H04N 7/16

(52) U.S. Cl. 725/134; 725/142; 725/89; 381/110; 704/200; 704/246; 704/251; 725/18; 725/19; 382/190

(57) ABSTRACT

The system of the present invention includes an output device for generating media representation of media content extracted from a media receiver. The system includes an extraction module for extracting of media content from the media receiver. The output device generates a representation of media content extracted. Additionally, a media transfer interface permits communication between the output device and the media receiver. The methods of the present invention include a extracting media content from a media receiver, generating a representation of media content, and communicating with the media receiver through a media transfer interface. Methods of the system further include scheduling actions of the media receiver to occur at predefined times, recording and playing media content, and generating a schedule display of media programs by performing optical character recognition on the schedule displayed on a schedule channel.

### CROSS-REFERENCES TO RELATED APPLICATIONS

This application claims the benefit of the following provisional patent applications, each of which is incorporated by reference in its entirety: U.S. Provisional patent application entitled “Printer Including One or More Specialized Hardware Devices” filed on Sep. 25, 2003, having serial No. 60/506,303, and U.S. Provisional patent application entitled “Printer Including Interface and Specialized Information Processing Capabilities” filed on Sep. 25, 2003, having serial No. 60/506,302.

This application is a continuation-in-part of the following co-pending U.S. patent applications (hereinafter referred to as the “Video Paper Applications”), each of which is hereby incorporated by reference in its entirety: U.S. patent application Ser. No. 10/001,895, “Paper-based Interface for Multimedia Information,” filed Nov. 19, 2001; U.S. patent application Ser. No. 10/001,849, “Techniques for Annotating Multimedia Information,” filed Nov. 19, 2001; U.S. patent application Ser. No. 10/001,893, “Techniques for Generating a Coversheet for a paper-based Interface for Multimedia Information,” filed Nov. 19, 2001; U.S. patent application Ser. No. 10/001,894, “Techniques for Retrieving Multimedia Information Using a Paper-Based Interface,” filed Nov. 19, 2001; U.S. patent application Ser. No. 10/001,891, “Paper-based Interface for Multimedia Information Stored by Multiple Multimedia Documents,” filed Nov. 19, 2001; U.S. patent application Ser. No. 10/175,540, “Device for Generating a Multimedia Paper Document,” filed Jun. 18, 2002; and U.S. patent application Ser. No. 10/645,821, “Paper-Based Interface for Specifying Ranges,” filed Aug. 20, 2003.

This application is a continuation-in-part of the following co-pending U.S. patent applications, each of which is hereby incorporated by reference in its entirety: U.S. patent application No. 10/081,129, to Graham, entitled “Multimedia Visualization and Integration Environment,” filed on Feb. 21, 2001; U.S. patent application Ser. No. 10/701,966, to Graham, entitled “Multimedia Visualization and Integration Environment,” filed on Nov. 4, 2003; U.S. patent application Ser. No. 10/465,027, to Graham, et. al., entitled “Interface For Printing Multimedia Information,” filed on Jun. 18, 2003; U.S. patent application Ser. No. entitled “Techniques For Displaying Information Stored In Multiple Multimedia Documents,” to Graham, et. al., filed on Jun. 18, 2003; U.S. patent application Ser. No. 10/174,522, to Graham, entitled “Television-Based Visualization and Navigation Interface, filed on Jun. 17, 2002; and U.S. patent application, to Graham, entitled “Multimedia Visualization and Integration Environment,” filed Mar. 3, 2004.

This application is also related to the following co-pending patent applications, each each of which is hereby incorporated by reference in its entirety: U.S. patent application entitled “Networked Printing System Having Embedded Functionality for Printing Time-Based Media,” to Hart, et al., filed Mar. 30, 2004, Attorney Docket Number 20412-8341; U.S. patent application entitled, “Printer Having Embedded Functionality for Printing Time-Based Media,” to Hart et al., filed Mar. 30, 2004, Attorney Docket No. 20412-08340; and U.S. patent application entitled, “Printer With Hardware and Software Interfaces for Peripheral Devices,” to Hart et al., filed Mar. 30, 2004, Attorney Docket No. 20412-08383; U.S. patent application entitled, “Printer User Interface,” to Hart et al., filed Mar. 30, 2004, Attorney Docket No. 20412-08455.

### BACKGROUND OF THE INVENTION

1. Field of the Invention

The present invention relates to systems and methods for capturing multimedia content. In particular, the present invention relates to a system and method for controlling an external multimedia receiver to record multimedia programs and capture multimedia schedule information.

2. Description of the Background Art

Home entertainment systems are a big market in today's society where watching the latest television programs and listening to radio programs are both very common and popular forms of entertainment. As entertainment systems become more advanced, however, viewers/listeners are demanding less cost and more flexibility, convenience, and control in their viewing of or listening to multimedia content.

Current entertainment systems allow users to have some control over which multimedia (e.g., radio or television) programs that the user listens to or watches, permitting a user to tailor the entertainment to his/her preferences. With regard to television, for example, some current technologies (e.g., digital video recorders, such as those manufactured and sold by TiVo®) permit a television viewer to set the system to automatically and regularly record all viewer-selected television programs so that the user can generate his/her own desired lineup of programs, rather than watching the regularly scheduled programming. However, for such technologies to schedule recording of programs, it is necessary for a viewer to download multimedia schedule information from the multimedia provider (e.g., a cable provider, digital cable provider, or satellite television provider). With these current technologies, the viewer is also forced to pay a subscription fee to have access and to download program schedule information. There is not currently any mechanism by which a user can directly obtain multimedia schedule information (in digital or paper-based format) from a multimedia schedule channel (i.e., directly from a television channel displaying television program scheduling information), nor is there any mechanism for eliminating the fee for this downloading schedule information.

Moreover, for many users, digital format is not the optimal format in which to view multimedia information. While viewing multimedia information in digital form is adequate for some users, many users find it easier to comprehend and assimilate information when the information is printed on a paper medium. This is also true with regard to multimedia program schedule information (e.g., television program schedule guide). Though paper-based multimedia program schedules are currently available, they tend not to be as up-to-date as digital schedules, or tend to contain programming information that is not accurate for all viewers/listeners in all areas. The digital program information, such as television program schedule information shown on a viewer's television scheduling channel or information that is downloaded from a multimedia service provider, is typically more current and accurate for the viewer's particular area. However, there is not currently available a mechanism for easily generating a paper-based version of this accurate and up-to-date digital program schedule.

In addition, the program schedule information that is currently available to a viewer/listener on a paper medium is cumbersome to review because it does not provide user-specific information, and it fails to provide an easy interface for accessing the information. For example, it is not possible for the user to generate a paper-based version of schedule information that is tailored to the viewer/listener's preferences and displays only the programs about which the user has an interest. Additionally, there is not currently available a paper program schedule that provides an interface for easily accessing the multimedia information associated with a scheduled program. The viewer/listener cannot refer to current paper schedules to directly record a program or request a program to play.

Therefore, what is needed is a system and methods that allow users to control multimedia content and to generate multimedia representations that allow convenient viewing of and access to multimedia information.

### SUMMARY OF THE INVENTION

The present invention overcomes the deficiencies and limitations of the prior art by providing a system and method for recording media content or capturing schedule information and for generating media representations. The system of the present invention includes an extraction module that extracts media content from the media receiver. The invention also includes an output device or printer for generating a media representation of media content extracted from a media receiver, and the invention includes a media transfer interface for permitting communication between the output device and the media receiver. The invention further includes media content recognition software that recognizes features in the media content, including faces, speech, text, etc. Processing logic controls the display of a user interface that allows the user to control the actions of the output device. The processing logic also controls the generation of a media representation. The representation can be generated in a paper-based format, in digital format, and in any other representation formats. Additionally, the invention includes external user interaction devices that permit a user to interact with the output device remotely.

The method of the present invention includes extracting media content from a media receiver, and generating a representation of the media content. Additionally, the methods include communicating with a media receiver through a media transfer interface. Methods further include scheduling actions (e.g., generation of a media representation) to be performed by the output device to occur at predefined times, and generating a schedule display of programs by performing optical character recognition on the schedule displayed on a schedule channel. In addition, the methods include recording media content and storing on a storage medium such that the content can later be played on a media display.

### BRIEF DESCRIPTION OF THE DRAWINGS

The invention is illustrated by way of example, and not by way of limitation in the figures of the accompanying drawings in which like reference numerals refer to similar elements.

FIG. 1 is a block diagram of a system for controlling an external multimedia receiver to record multimedia content and capture schedule information.

FIG. 2 is a block diagram of an exemplary architecture for one embodiment of the system of FIG. 1.

FIG. 3 is a representation of an exemplary profile for a multimedia schedule that can be stored on a printer.

FIG. 4a is a graphical representation of an exemplary multimedia schedule that is copyable.

FIG. 4b is a block diagram of an exemplary format for the multimedia schedule of FIG. 4a.

FIG. 5 is a representation of an exemplary format for a multimedia schedule, including multimedia schedule information.

FIG. 6 is a flowchart of a method for updating a multimedia schedule.

FIG. 7 is a flowchart of a method for updating a multimedia schedule database.

FIG. 8 is a flowchart of a method for advancing a multimedia schedule display.

FIG. 9 is a flowchart of a method for rewinding and advancing to the next channel in a multimedia schedule display.

FIG. 10 is a graphical representation of a button on a printer keypad for printing a multimedia schedule.

FIG. 11 is a flowchart of a method for printing a multimedia schedule.

FIG. 12 is a graphical representation of an exemplary multimedia schedule on a printer output medium.

### DETAILED DESCRIPTION OF THE PREFERRED EMBODIMENTS

A system and method for controlling an external multimedia receiver 104 to record multimedia information in the form of multimedia programs and to capture schedule information is described. For the purposes of this invention, the terms “multimedia,” “multimedia content,” “multimedia data,” or “multimedia information” refer to any one of or a combination of text information, graphics information, animation information, sound (audio) information, video information, and the like. In addition, the terms “multimedia programs” or “programs” refer to a type of multimedia that comprises segments of multimedia content, such as a television broadcast program, a movie, a radio broadcast program, a song played on the radio, or other any other user-defined segment of multimedia content, of any length.

For purposes of this invention, the terms “print” or “printing,” when referring to printing onto some type of medium, are intended to include printing, writing, drawing, imprinting, embossing, and the like. Also for purposes of this invention, the output generated by the system will be referred to as a “multimedia document,” a “multimedia representation,” a “document,” a “paper document,” or either “video paper” or “audio paper.” While the words document and paper are referred to in these terms, output of the system in the present invention is not limited to such a physical medium, like a paper medium. Instead, the above terms can refer to any output that is fixed in a tangible medium. In some embodiments, the output of the system of the present invention can be a representation of multimedia content printed on a physical paper document. In paper format, the multimedia document takes advantage of the high resolution and portability of paper and provides a readable representation of the multimedia information. According to the teachings of the present invention, a multimedia document may also be used to select, retrieve, and access the multimedia information. In other embodiments, the output of the system can exist in digital format or some other tangible medium. In addition, the output of the present invention can refer to any storage unit (e.g., a file) that stores multimedia information in digital format.

Various different formats may be used to store the multimedia information. These formats include various MPEG formats (e.g., MPEG 1, MPEG 2, MPEG 4, MPEG 7, etc.), MP3 format, SMIL format, HTML+TIME format, WMF (Windows Media Format), RM (Real Media) format, Quicktime format, Shockwave format, various streaming media formats, formats being developed by the engineering community, proprietary and customary formats, and others.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described primarily with reference recording of television programs and capturing of television program schedule information. However, the present invention applies to the recording of any type of multimedia information and the capturing of any type of multimedia scheduling data.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

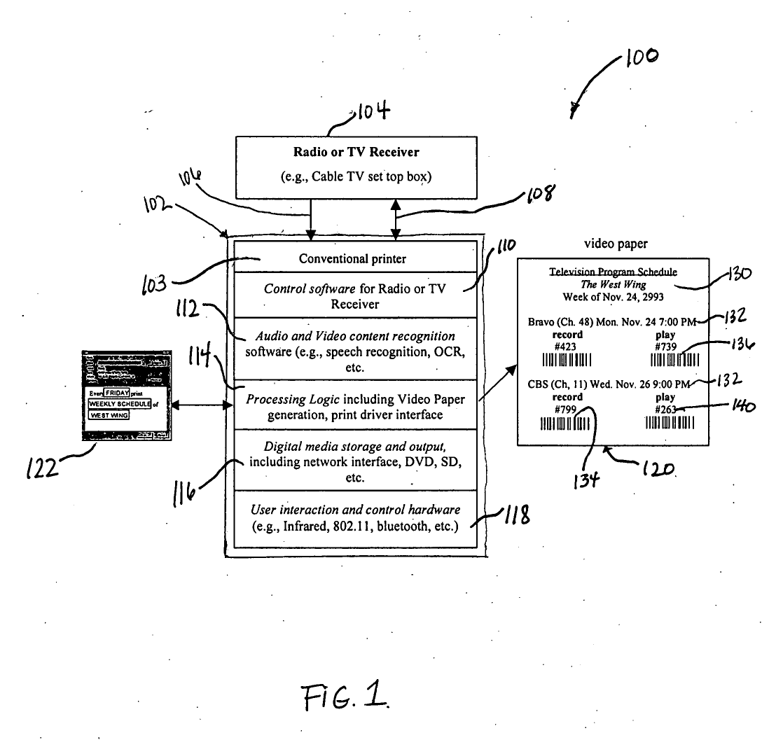

Referring now to FIG. 1, an exemplary system 100 for controlling an external multimedia receiver 104 to record programs or capture schedule information upon which the present invention operates is shown. In this embodiment, the multimedia receiver 104 in FIG. 1 is shown to be a radio or television (TV) receiver. However, the multimedia receiver 104 can also comprise other types of receivers or devices that can transfer other types of multimedia information. Examples of multimedia receivers include, but are not limited to, a cable TV set top box, a satellite receiver, a broadcast TV receiver, a digital video recorder, a web server, a cell phone, a personal digital assistant (PDA), a video recording or pass-through device, such as a video camera, a digital camera, or a web camera, and the like.

In FIG. 1, the augmented output device or printer 102 comprises a number of components that include, but are not limited to a conventional printer 103, control software 110, audio and vide content recognition software 112, processing logic 114, digital media storage and output 116, and user interaction and control hardware 118. The conventional printer 103 component of the printer 102 can include all or some of the capabilities of a standard or conventional printing device, such as an inkjet printer, a laser printer, or other printing device. Thus, conventional printer 103 has the functionality to print paper documents, and may also have the capabilities of a fax machine, a copy machine, and other devices for generating physical documents. More information about printing systems is provided in the U.S. patent application entitled “Networked Printing System Having Embedded Functionality for Printing Time-Based Media,” to Hart, et al., filed Mar. 30, 2004, Attorney Docket Number 20412-8341, and which is incorporated by reference herein, in its entirety.

As shown in FIG. 1, printer 102 includes other modules such as hardware and control software 110 for controlling the multimedia receiver 104. The printer 102 receives data on signal line 106, including multimedia programs and schedule information from the multimedia receiver 104, and this data is transferred over some type of hardware cable connection 108 between the printer 102 and the multimedia receiver 104. In the FIG. 1 embodiment, this connection 108 is shown as a serial control line, but this connection might also be a parallel cable connection or other type of connection. The control software 110 can send commands to the multimedia receiver 104 causing the multimedia receiver 104 to take certain actions. The control software 110 also can run other types of software that control certain actions by the multimedia receiver 104. For example, the control software 110 can run other software to control the scheduling of actions by the multimedia receiver 104, software that extracts multimedia content frames from the multimedia receiver 104, software that recognizes content of a still multimedia frame, software that monitors commands from an external computer (not shown) connected to the system 100, software that affects recording and playback of video or audio content, software that runs a web server, and the like. The control software 110 and its functions will be discussed in more detail below.

The printer 102 further comprises multimedia content recognition software 112 that recognizes specific features of the multimedia content received from the multimedia receiver 104. For example, the multimedia content recognition software 112 can include speech recognition software, speaker recognition software, optical character recognition software, face detection software, face recognition software, keyframe selection software, and the like.

In the embodiment shown in FIG. 1, the printer 102 additionally comprises processing logic 114 that controls the printer's 102 interactions with the user through a print driver interface 122 and controls the printer's 102 generation of a multimedia document 120. For example, the processing logic 114 manages the display of a print driver interface 122 that allows the user control certain printer actions, such as scheduling of recording events or setting a weekly time for printing of a television program schedule. Alternatively, the functionality of the print driver interface 122 can be provided by a web interface, allowing the user to manage printer actions, such as event scheduling, through this web interface. In the example shown in FIG. 1, the print driver interface 122 shows that the user has made selections that will include the printing of a television schedule document that is limited to display only the scheduled play times of the television program, “West Wing.” In this example, the user has selected to have the weekly “West Wing” schedule automatically printed every Friday. Thus, the system 100 will be set to automatically print out the “West Wing” schedule each week without any further interaction from the user, and will continue this weekly printing until the user states otherwise. The system 100 can also be set to generate the schedules of a user-defined collection of television programs each week, according to the user's preferences. As another example, the user might alternatively want a printed document showing the entire television program schedule for the week or for the month, without any user-preference filtering.

Additionally, the print driver interface 122 can allow the user to set formatting preferences with regard to the multimedia document 120 produced. The user can set preferences as to document format and layout, font type and size, information displayed in each line, information displayed in a header, size and location of schedule columns, font colors, line spacing, number of words per line, bolding and capitalization techniques, language in which the document is printed, paper size, paper type, and the like. For example, the user might choose to have the multimedia document 120 that includes a header in large, bold font showing the name of the television program being displayed in the schedule and the week for which scheduling information is included. As another example, the user might choose to specify a particular document layout that displays information about which television networks are showing a particular television program, the channels on which the program is shown, and the dates and times during which the program will be shown.

The multimedia document 120 generated by the printer 102 can comprise various formats. For example, the multimedia document 120 can comprise a paper document, such as audio paper or video paper of the form shown in FIG. 1. The multimedia document 120 produced by the printer 102 can be also stored on digital media. As shown in FIG. 1, this embodiment of the printer 102 includes digital media storage and output 116. The digital media writing hardware can include, for example, a network interface card, a digital video disc (DVD) writer, a secure digital (SD) writer, a compact disc (CD) writer, and the like.

The multimedia document 120 can have a number different types of layouts and can display various types of information. As described above, the document 120 can include program schedule information tailored to a user's preferences. FIG. 1 provides an example of a video paper document displaying scheduling information for the television program “West Wing,” during the week of November 24. The video paper document 120 in the FIG. 1 example includes a document header 130 that lists the type of document (Television Program Schedule), the name of the program for which schedule information is displayed, and the time period for which schedule information is displayed. In the FIG. 1 example, the multimedia document 120 further includes schedule information headers 132 displaying information about each scheduling of the television program. In this example, the schedule information header 132 displays the television networks, Bravo and CBS, that are showing “West Wing” during the week of November 24, and the channels (Ch. 48 and Ch. 11) on which “West Wing” will be shown. The schedule information header 132 also shows the day of the week for each showing of “West Wing,” the date, and the time of each showing.

The user might also choose to have included in the multimedia document 120 some of the audio information for a program displayed as text or some other type of text information about the program. For example, the user may choose to have a portion of the transcript of a TV or radio program displayed next to the scheduling information for that program. As another example, the user might opt to include in the printed schedule a text description of each program, such as a brief summary of a particular episode scheduled, a review of a particular movie, and the like. The user can use the print driver interface 122 to identify techniques to be used for converting the audio information to text information (i.e., techniques for generating a text transcript for the audio information), the format and styles for printing the audio transcript (which may be the same as for printing text information), formats and styles for printing summary text about a program, and the like.

A paper version of the multimedia document 120 generated by printing the printable representation on a paper medium also provides an interface for accessing or retrieving multimedia information in electronic form. The paper document may thus be used as an indexing and retrieval tool for retrieving multimedia information. In one embodiment, user-selectable identifiers are printed on the multimedia document 120. In the embodiment depicted in FIG. 1, user-selectable identifiers are printed as barcodes, including a play barcode 136 and a record barcode 134. In the example of FIG. 1, a barcode is printed for each schedule segment that is printed on the page. For example, there is a play barcode 136 and a record barcode 134 associated with the schedule of program “West Wing” that will be shown on the television network, Bravo, and there is also play barcode 136 and a record barcode 134 associated with the CBS schedule. In alternative embodiments of the present invention, various other techniques, besides barcodes, may be used to represent the user-selectable identifiers.

The user-selectable identifiers provide a mechanism for the reader of the multimedia paper document to access or retrieve multimedia information using the multimedia paper document. As depicted in FIG. 1, play barcode 136 corresponds to a control that allows a user to request playback of multimedia information corresponding to user-selected segments. Also depicted in FIG. 1, record barcode 134 corresponds to a control that may be used by a user to schedule recording of multimedia information corresponding to user-selected segments. A user selects “record” or “play” by scanning the appropriate barcode on the printed document using any type of device that has a barcode scanner incorporated into it, such as a cell phone or a PDA. As another example, the user may alternatively direct the system 100 to act by typing into a remote control or other device the numerical identifiers 140 printed on the paper document. The numerical identifier 140 listed over the play barcode 136 will cause a program to play when typed into a keypad, and the numerical identifier 140 listed over the record barcode 134 will schedule recording of a program when typed into a keypad.

In the example of FIG. 1, the user can select the play barcode 136 to play a program. According to an embodiment of the present invention, upon selecting the play barcode 136 control, a signal is transmitted from the user's selection device (e.g., a barcode scanner) to the printer 102. The printer 102 is capable of retrieving multimedia information corresponding to the user-selected segments. The signal communicated to the printer 102 from the selection device may identify the schedule segment selected by the user, the location of the multimedia content to be played, the multimedia paper documents from which the segments are to be selected, information related to preferences and/or one or more multimedia display devices (e.g., a television set) selected by the user, and other like information to facilitate retrieval of the requested multimedia information. For example, the system 100 can access a program from the printer 102 storage that the user previously recorded, and the system can play this program on the user's command. Alternatively, the system 100 might access a program that was not previously recorded by the user, but instead is stored remotely on the user's computer, on the web, on a server, or at another location. As another example, the user might generate a document that summarizes the contents of the video collection on the system, and from this video library document the user can choose a video to be played.

In the FIG. 1 example, the user can also select the record barcode 134, to record a program. Upon scanning the record barcode 134, a signal is communicated to the printer 102 causing the printer 102 to begin recording the selected program if the program is currently being broadcast. If the selected program is not currently being broadcast, the printer 102 instead schedules the automatic recording of the program to occur at a later time when the program is going to be broadcast.

Beyond generating printable representations of multimedia program schedules, the system 100 can also generate other types of printable representations of multimedia information, including video and audio data. According to an embodiment of the present invention, the printable representation (e.g., video paper) of the video information includes keyframes of video content that are extracted from the video information and displayed on the representation. In this embodiment, the layout and format information may specify the sampling rate for extracting the keyframes, the number of keyframes that are to be extracted from the video information, the order and placement of the keyframes on the medium, and other like information. For video information, the printer 102 can extract keyframes that capture salient features of the video (or keyframes that are informative) for a particular segment of the multimedia information. Additionally, the printer 102 may include feature recognition capabilities (e.g., face recognition, face detection, OCR, and the like), allowing the user to search within a video segment for items of interest, such as particular face images, particular words displayed as text, and the like. For example, the printer 102 can use face recognition techniques to extract keyframes displaying images of the faces of particular persons for which the user has an interest in viewing.

The user can also create printable representations of audio information that can include the keyframes described above or other data. For example, the user might generate a printable representation of a radio news program, such as the hourly broadcast by the National Public Radio (NPR) station, or a 30-minute segment of a KCBS broadcast. In this example, the printer 102 uses speech recognition techniques to identify the speech of known radio announcers. Additionally, the printer 102 can use a variable vocabulary for speech recognition that is based on current news as determined from online newspapers or other sources. In this example, the printer 102 can also use speech detection techniques based on the typical characteristics of a news broadcast (i.e., multiple speakers that each speak for limited durations) to segment the broadcast into logical parts and construct a printable representation (e.g., audio paper). The printer 102 can extract keyframes of audio data that include information in which the user has an interest, and the printer 102 can create a printable representation of the data. This printable representation could be a paper abstract about the radio news program, or the representation could be stored digitally for later access, depending on the quality of the recognition results. As another example, the user might generate a printable representation of a radio program, such as NPR's Car Talk broadcast, which would involve significantly more dialog between the participants than a news broadcast. The printer 102 could again use speech recognition for known announcers and speech detection based on the typical characteristics of radio programs to segment the broadcast and construct a printable representation.

In other embodiments of the invention, the printer 102 conducts web searching to provide more detailed information about an audio or video program. For example, a user can create a printable representation of a radio program, and in addition to segmenting and producing the printable representation, the printer also applies specialized techniques for personal name recognition. The printer 102 can then conduct web searching using an image search engine, such as the Google™ image search engine or other similar engines, to find face images for the persons mentioned in the radio program. In this example, the images can be displayed to the user in the print dialog box and/or generated as a printable representation, such as in an audio paper format. As another example, a user can choose to create a printable representation of a radio program, in which the printer also applies specialized techniques for personal name recognition followed by web searching using a search engine, such as Google™, to find home pages for the persons mentioned in the radio program. These home pages can be displayed to the user in the print dialog box and/or generated as a printable representation, such as in an audio paper format. Additionally, barcodes might be included in the printable representation, and the barcodes would provide for indirect retrieval of the home page or a stand-alone digital encoding of the contents of the home page.

The printer 102 shown in the FIG. 1 embodiment also comprises user interaction and control hardware 118 and software, permitting the user to interact with the printer 102, and thereby control actions of the multimedia receiver 104. For example, the user can control playing or recording operations with a standard remote control device (not shown) using infrared control, an 802.11 bar code scanner, Bluetooth® wireless technology, and the like.

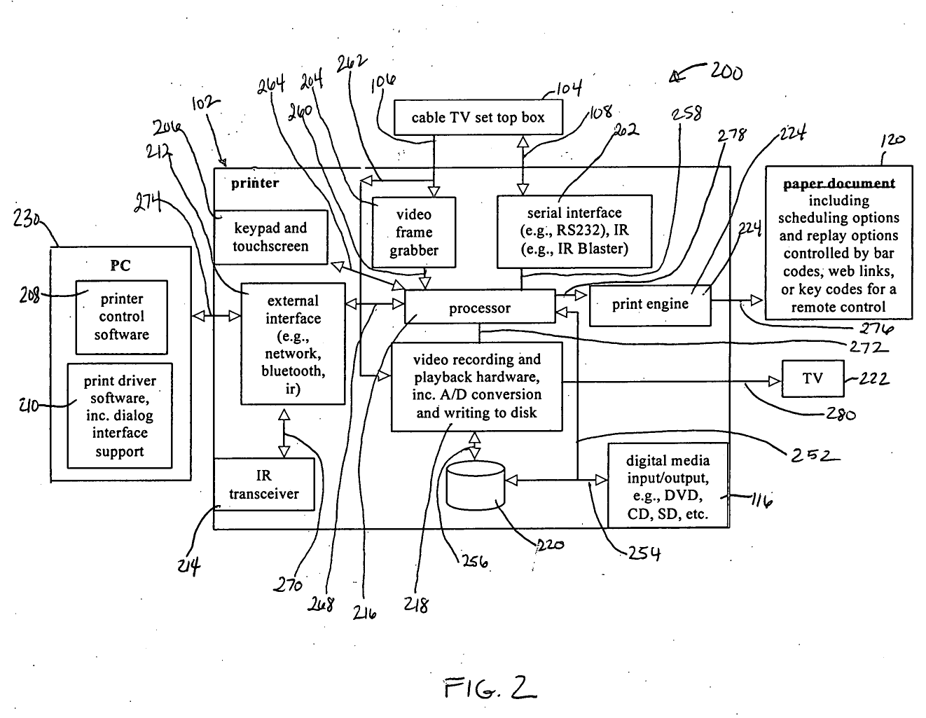

Referring now to FIG. 2, there is shown the architecture of an embodiment of the present invention. In this embodiment, the system 200 comprises a multimedia receiver 104 that is a cable TV set top box, and a printer 102. As described previously, multimedia data is transferred over a hardware connection 106 from the multimedia receiver 104 to the printer 102. In this embodiment, the multimedia data comprises video data that is transferred from a cable TV set top box to the printer 102. FIG. 1 also shows the printer 102 controlling and sending commands to the multimedia receiver 104 over the hardware connection 108. This control can either occur over the same hardware connection through which video data is transferred, or it can occur over a separate hardware connection.

As shown in FIG. 2, the system 200 further comprises a hardware interface 202 or media transfer interface that permits communication between the printer 102 and the multimedia receiver 104. This hardware interface 202 can comprise a serial interface, (such as an RS232 interface), an infrared interface, (such as an infrared blaster), and the like. The hardware interface 202 includes the capabilities to capture multimedia data from the multimedia receiver 104. The hardware interface 202 also allows the printer 102 to send commands to the multimedia receiver 104 and to control the multimedia receiver 104. For example, the printer 102 can turn the multimedia receiver 104 on and off, can cause the multimedia receiver 104 to change channels, and the like. The processor 216 can transmit commands over bus 258 from the user to the multimedia receiver 104 through the hardware interface 202.

The system 200 further comprises control software (not shown) on the printer 102 that manages the operations of the multimedia receiver 104. Control software (not shown) sends commands to the multimedia receiver 104 causing the multimedia receiver 104 to take some defined action. For example, the multimedia receiver 104 might be asked to advance forward a channel, to advance backward a channel, and the like.

In one embodiment, the system 200 includes the capability to automatically extract program schedule information from a schedule channel on a TV, and construct a TV program schedule database or storage 220. Multimedia extraction module or a video frame grabber 204, captures one or more video frames from the multimedia data transferred over bus 106 to the printer 102 from the multimedia receiver 104. Each frame can be transferred over bus 260 to a processor 216 that controls each of the operations of the printer 102 and transfers the data to the appropriate part of the printer 102 for further processing. For schedule generation, control software (not shown) on the printer 102 runs content recognition software that performs optical character recognition (OCR) processes on the contents of a still frame provided by the video frame grabber 204. The content recognition software is provided information about the expected layouts and contents of schedule screen shots. For example, a cable TV set top box can be set to a scheduling channel that displays television program schedules. The video frame grabber 204 can capture a still frame of the scheduling page, and content recognition software (not shown) can perform OCR on the contents of the frame. This allows the user to create his or her own program guide showing a schedule of television programs. The user can store this program guide, print the guide, customize the guide to the user's preferences, update the guide regularly, etc. These operations are described in more detail below.

The system 200 further comprises control software (not shown) on the printer 102 that runs scheduling software (not shown) to keep track of the time and to construct schedules that determine when an action will occur. For example, the printer 102 can be set to turn on the multimedia receiver 104 on a certain date and at a certain time of day. Once the printer 102 has turned the multimedia receiver 104 on, the printer 102 can instruct the multimedia receiver 104 to display a schedule page for television programs. Additionally, the printer 102 can be set to act on a recurring schedule. For example, the printer 102 can command the multimedia receiver 104 to capture a new schedule page every Tuesday at a

In the embodiment of FIG. 2, the system 200 also includes a television video recorder, with recording and playback hardware 218. Control software (not shown) on the printer 102 runs recording and playback software that writes multimedia data to disk and plays it back in response to commands received from an external interface 212 or from the printer keypad and touchscreen 206. The multimedia data received by the printer 102 from the multimedia receiver 104 can be transferred to recording and playback hardware 218 through bus 262. The data can undergo A/D conversion and can be written to disk or some other storage 220 on the printer 102. The data is transferred to storage 220 over bus 256. The storage 220 is not limited to the printer 102, but can also be located elsewhere, on the personal computer (PC) 230 or a server, for example. Processor 216 is coupled to and controls the recording and playback hardware 218, and processor 216 can transfer data to the recording and playback hardware 218 through bus 272.

Storage 220 may be configured to store the basic programming and data constructs that provide the functionality of the computer system and of the present invention. For example, according to an embodiment of the present invention, software implementing the functionality of the present invention may be stored in storage 220. This software may be executed by processor(s) 216 and its associated memory (not shown). In a distributed environment, the software may be stored on a plurality of computer systems and executed by processors of the plurality of computer systems. Storage 220 may also provide a repository for storing various databases and files that may be used by the present invention. For example, the multimedia documents may be stored in storage 220. Storage 220 may include a number of memories including a main random access memory (RAM) for storage of instructions and data during program execution and a read only memory (ROM) in which fixed instructions are stored. Storage 220 may also include persistent (non-volatile) storage for program and data files, such as a hard disk drive, a floppy disk drive along with associated removable media, a Compact Digital Read Only Memory (CD-ROM) drive, an optical drive, removable media cartridges, and other like storage media. One or more of the drives may be located at remote locations on other connected computers.

The processor 214 is also coupled to and controls a digital media input/output 108. The processor 216 transfers information to and receives information from digital media input/output device 116, through bus 252. Multimedia documents created can be converted into some type of digital format, as described previously. The digital media writing hardware can include, for example, a network interface card, a DVD writer, a secure digital (SD) writer, a compact disc (CD) writer, and the like. The digital output documents can be stored on digital media, including a CD, a DVD, flash media, and the like. Thus, the user can create a digital output version of input audio or video file, and this can be viewed on a specified target device, such as a PC, a cell phone, or a PDA.

When a user requests the recording or playback of data, the data stored as digital media can then be transferred back to storage 220 over data bus 254, and accessed by recording and playback software and hardware 218 through bus 256. If the user instructed system 200 to play the multimedia, the recording and playback hardware 218 transmits data over bus 280 to display device 222 and the multimedia content plays the on a display device 222. If the user instructed system 200 to record multimedia, the recording and playback hardware 218 records the designated multimedia content using digital media input/output device 116. In this embodiment, the display device 222 is a TV, but the multimedia data might also be displayed on other devices, such as a cell phone screen, a computer screen, a PDA, or other display. The display device 222 can include a cathode ray tube (CRT), a flat-panel device such as a liquid crystal display (LCD), a projection device, and the like. For example, the user might use a remote control or enter into the printer keypad or touchscreen 206 a command to play a particular movie. The recording and playback software would then access the previously stored movie data from the storage 220 and then play the movie on the TV for the user to view.

The processor 216 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. Main memory (not shown) may store instructions and/or data that may be executed by processor 216, including the software and other components of system 200. The instructions and/or data may comprise code for performing any and/or all of the techniques described herein. Main memory (not shown) may be a dynamic random access memory (DRAM) device, a static random access memory (SRAM) device, or some other memory device known in the art.

In another embodiment, the system 200 further comprises control software that runs a web server with a common gateway interface (CGI) that controls the schedule for recording and playback. This would allow a user, for example, to request a web page that displays a list of television programs or movies available, and the user could select the movie or program of his choice to be played on the TV or to be recorded. The user might additionally command the printer to search for and provide a list of or download all of the movies in which a particular actor starred or all movies that have won an Oscar for Best Picture, for example.

The embodiment of in FIG. 2, also allows a user to interact with system 200. A user control device, such as a keypad or touchscreen 206, can be incorporated into the printer 102, allowing the user to communicate directly with the printer 102. This keypad or touchscreen 206 allows the user to enter information into the printer 102, and these commands are then sent to the processor 216, through bus 264, and the processor 216 manages execution of the instructions. For example, the user may request the printing of a TV schedule by entering a command into the keypad or touchscreen 206.

The printer 102 shown in embodiment of FIG. 2 also includes an external interface 212 that allows the printer interact with an external device, such as a personal computer (PC) 230, a portable computer, a workstation, a computer terminal, a network computer, a mainframe, a kiosk, a standard remote control, a PDA, a game controller, a communication device such as a cell phone, or any other data processing system. In the embodiment shown in FIG. 2, an infrared (IR) transceiver 214 can receive IR signals from an external device, which can be transmitted through signal line 270 to external interface 212. Thus, as an alternative to the keypad or touchscreen 206 on printer 102, the user can use the remote control or other device to transmit commands to the printer 102. For example, the user might request printing of a TV schedule by typing in a specified command on a standard IR remote control, or a user might request recording of a program by scanning a barcode on a printed document. Examples of other input devices include, but are not limited to a keyboard, pointing devices, a mouse, trackball, touchpad, a graphics tablet, a scanner, a barcode scanner, a touchscreen incorporated into the display, audio input devices such as voice recognition systems, microphones, and other types of input devices. As described above, control software on the printer 102 runs recording and playback software that writes multimedia data to disk and plays it back in response to commands received from an external interface 212. Some examples of an external interface 212 include an IR remote control, a network interface, a Bluetooth® interface, and the like.

As stated above, the user can also use the PC 230 to send commands to the printer 102 through bus 274, and the PC 230 interacts with the external interface 212. Control software on the printer 102 runs monitoring software that responds to commands from the PC. For example, the user might request that the printer 102 print a schedule in paper format, and the user can set certain parameters for the print job. If the schedule is printed in video paper format, it will include bar codes, web links, key codes for a remote control, or another marker type under each video frame that will control the scheduling, recording, and replay of the TV program, as described previously. In this example, the print command will be transmitted through the external interface 212 to the processor 216, which is coupled to and transfers the information to the print engine 224, through bus 278. The print engine 224 sends information over bus 276 to direct the printing of a multimedia document 120, which in this example is a paper document. The monitoring software will also update an internal table that stores the correspondence between the codes printed on the paper and the action that can be executed on the printer 102 in response to those codes.

The system 200 of FIG. 2 further comprises printer control software 208 that runs on the PC 230. This printer control software 208 can be used to schedule the recording of TV programs on the printer 102, the printing of schedules, etc. This functionality can be provided by a stand-alone software application or it could be provided by a CGI interface in the web server on the printer that can be controlled with a normal web browser, such as Microsoft® Internet Explorer, Netscape® Navigator, Mozilla, Opera Internet Browser, etc. In addition, the PC 230 shown in the embodiment in FIG. 2 also runs print driver software that includes dialog interface support. The user can interact with system 200 through the print driver dialog, and the user can request, for example, that the printer 102 generate video paper with specified parameters.

The embodiment of FIG. 2 shows certain components and software included within the printer 102, and others included within the connected PC 230. However, any software and other components shown as part of the printer might instead be located on the PC 230, in other embodiments. Additionally, in some embodiments, the printer control software and print driver software shown on the PC 230 might instead by incorporated into the printer 192. Thus, in some embodiments, the PC 230 is an optional part of the system and the printer 102 is a standalone device providing user interfaces and providing all of the functionality associated with controlling the multimedia receiver 104 to record programs and capture schedule information.

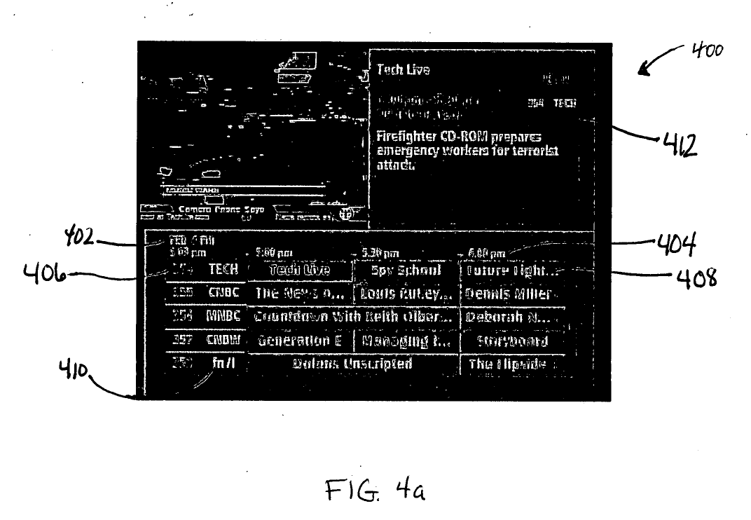

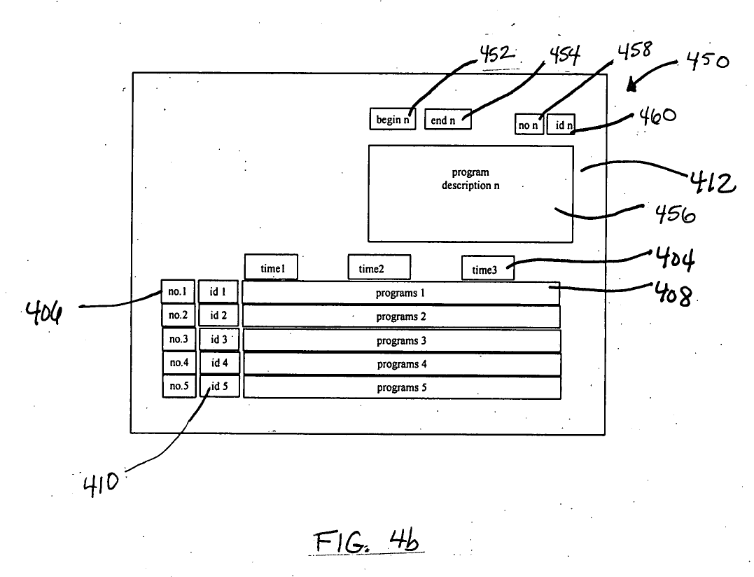

The printer 102 described in this embodiment of the invention, in addition to performing the full functions of a normal printer, also includes a complete television video recorder, as described above. In summary, this system 200 comprises control and scheduling software that can perform a number of functions including, but not limited to, recording TV programs as instructed by the user, automatically extracting program schedule information from a schedule channel and constructing a program database. The system 200 performs further functions including generating paper documents that both summarize recorded programs and summarize schedules of upcoming programs, and that also provide a user interface for recording and replaying programs. In addition, the system 200 responds to commands from a user requesting the printer 102 to print a schedule, record a program, and replay a recorded program. The operations of the system 200 are described in more detail below, in reference to FIGS. 4-12.

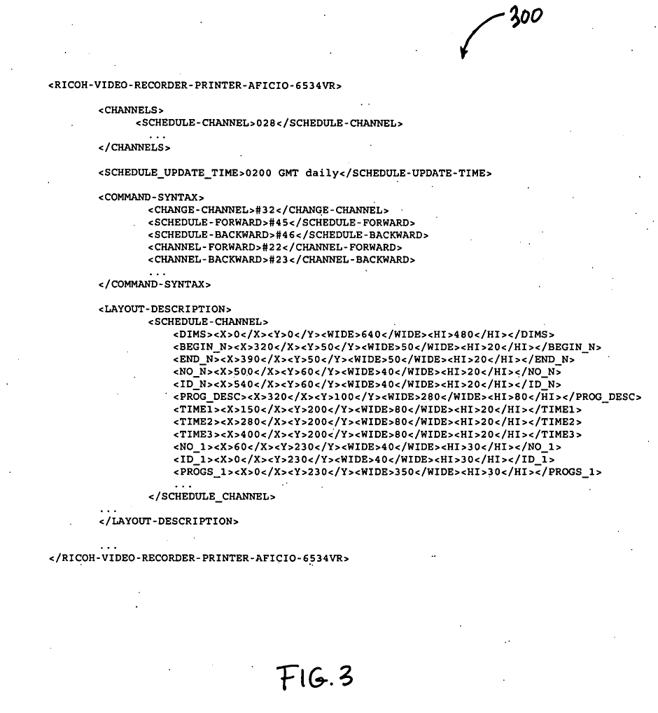

In operation, the “Update Schedule” command permits a user to obtain current information about scheduling of multimedia content. With regard to the system 200, the “Update Schedule” command would provide updated information about the scheduling of TV programs. When a user enters this command (or the printer executes it automatically), the printer 102 reads the schedule channel from a profile 300 stored on the printer. An example of such a profile 300 is shown in FIG. 3. The profile 300 can be created at the time of installation of the system 200. The user can choose, from the library of layouts, which layout best matches the schedule shown on the user's scheduling channel. As an alternative to the user-defined profile 300, the system could also match the screen on the schedule channel to entries in the library of expected layouts and then automatically choose the format that matches.

Referring now to FIG. 3, there is shown an example of a profile 300 for a schedule. The profile 300 lists the number of the channel that broadcasts the schedule. In the example of FIG. 3, the schedule channel is listed as TV channel 28, and this is shown in the profile 300 as “<SCHEDULE_CHANNEL>028</SCHEDULE-CHANNEL>.” The profile 300 further lists the times for schedule updates to occur, and this timing for updates can, for example, occur regularly. For example, in the profile 300 of FIG. 4, the schedule updates occur at 2 o'clock daily, and this is shown in the profile 300 as “<SCHEDULE_UPDATE_TIME>0200 GMT daily</SCHEDULE-UPDATE-TIME>.” The profile 300 also includes the expected layout of the schedule, which is chosen from a library of expected layouts of schedules, such as a library that includes a number of standard layouts used by TV program scheduling services. For example, in the profile 300 of FIG. 3, the expected layout is defined under “<LAYOUT-DESCRIPTION>,” and it describes not only the boxes that will bound information displayed on the schedule, but it also shows information that will be included in the schedule, such as information about times of programs, program description, channel number, ID number, etc.

Referring now to FIG. 4a, there is shown an example of a schedule screen 400. In this example, the schedule screen displays information about TV program scheduling. The schedule screen 400 includes a date field 402 that lists the date of the schedule, which in this example is Friday, February 6. The schedule screen 400 further includes a program field 408, listing each TV program name or type. A time field 404, in the schedule lists the scheduled time for each TV program to appear on the TV. Additionally, the schedule screen 400 comprises a channel field 406, showing the channel on which each TV program will be displayed. A network field 410, shows which TV station or network with which each TV program is associated. In FIG. 4, the schedule screen 400 further comprises a preview field 412 that displays preview information about a selected program. In the FIG. 4 example, the preview field 412 displays information about selected TV program “Tech Live,” including the title of the program, the beginning and end time of the program, the channel, the TV network, the rating of the program, and a photo and short description of the program.

Referring now to FIG. 4b, there is shown an example layout 450 of the schedule screen of FIG. 4a. In this example, the layout 450 shown has a similar format to the layout of the schedule screen 400 shown in FIG. 4a. The layout 450 includes a program field 408 where program names or types can be listed, and a time field 404 where program times can be listed. The layout 450 further includes a channel field 406 for TV program channels, and a network field 410 for TV program networks or stations. In the preview field 412 there is shown a program description field 456 where a short text description of the program is given. Additionally, the preview field 412 includes a beginning time field 452, an end time field 454, a preview program channel field 458, and a preview program network field 460, each listing specifications of the program being previewed.

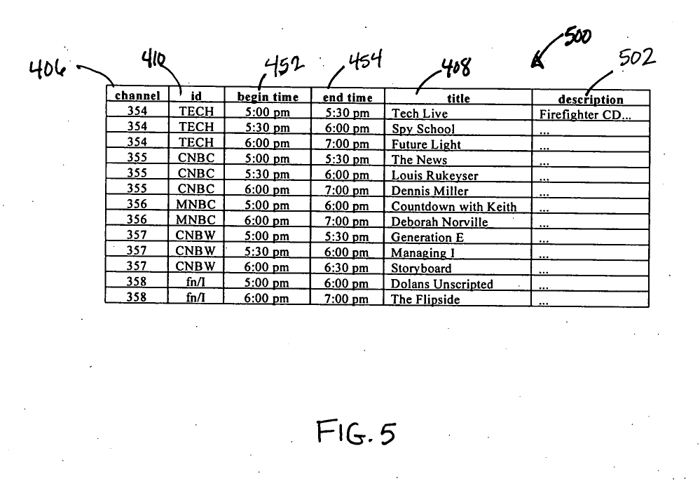

The OCR process uses the description of the schedule layout 500 to constrain its processing. A video frame containing a portion of a TV schedule is provided, and the OCR process creates commands that update the database of schedule entries for each time and channel. FIG. 5 shows an example of the database update commands 500 that were created from the schedule fragment shown in FIGS. 4a and 4b. Similar to the fields of FIGS. 4a and 4b, there is also a channel field 406, an network (ID) field 410, a beginning time field 452, an end time field 454, a program field 408, and a program description field 502. The output of the OCR process is a set of commands that update a data structure that describes a timeline of TV programs. This data structure could be a structured query language (SQL) database or it could be stored as a flat file in moving picture experts group, version 7, format (MPEG7). This data structure could also be stored in TV-Anytime format. The data structure includes slots for blocks of time and within each block of time there is a block of space available for channels. Each of those time/channel slots can be filled with program information that includes a title, identifier, and textual description for the program. The printer 102 software could generate the identifier by reading a counter, such as a barcode_id counter. Additionally, the identifier could be generated by looking up the video cassette recorder (VCR) Plus code. In either example, the identifier can eventually become a part of the bar code that is printed on paper documents generated by the system.

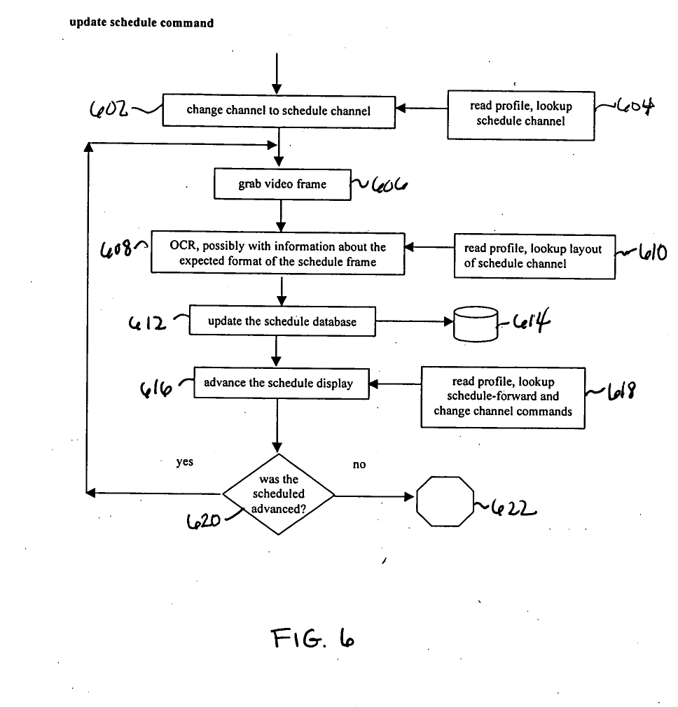

Referring now to FIG. 6, there is shown a flowchart that describes the “Update Schedule” command. The system 200 is coupled to a control program that runs the subroutine process, as described below. The user enters an “Update Schedule” command into the system 200 or the system executes it automatically, perhaps according to a schedule. The system 200 reads the profile and looks up the schedule channel 604 to which the multimedia receiver 104 should be turned. The printer 102 commands the multimedia receiver 104 to change 602 to the schedule channel. The video frame grabber 204 of the printer 102 grabs 606 a video frame from the multimedia receiver 104. The printer 102 performs OCR 608 on the video frame, possibly with information about the expected format of the schedule frame. The printer 102 reads 610 the profile information to determine the layout of the schedule channel, if such profile information is available. If, however, the profile 300 for the schedule screen 400 is not pre-defined by the user, the printer 102 may not yet have the schedule format at this point, and may have to automatically determine the format. After the OCR process is performed, the printer 102 updates 612 the schedule database, storing the updates in storage 614, and the printer 102 advances 616 the schedule display. To advance 616 the schedule display, the printer 102 reads 618 the profile to determine the schedule-forward and change channel commands. If the schedule was not advanced during this process, the process then stops at this point, meaning that the current schedule available is already updated to the most current schedule. If the schedule was advanced, then the process starts over, and the printer once again grabs 606 a video frame, and continues through the OCR, update, and schedule advance steps until the schedule has been advanced to the point where the schedule is the current schedule available.

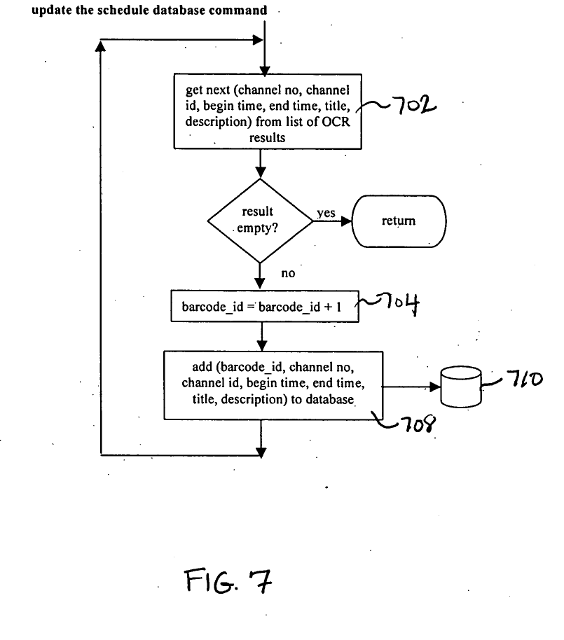

Referring now to FIG. 7, there is shown a flowchart describing the “Update the Schedule Database” command 612. The system 200 is coupled to a control program that runs the subroutine process, as described below. The system 200 gets 702 the next channel number, channel network or ID, beginning time, end time, program title, and program description from the list of OCR results. If the result list is empty, the printer 102 sends a return result to the control program, and the printer 102 returns to its previous state and ends the command. If the result list is not empty, the printer 102 generates a barcode 704, where barcode_id=barcode_id+1. The printer 102 adds 708 the barcode_id, channel number, channel network or ID, beginning time, end time, program title and program description to the database, and this information is sent to storage 710. The process then starts over with get 706 next set of information from the list of OCR results command, and the process continues until the result is empty.

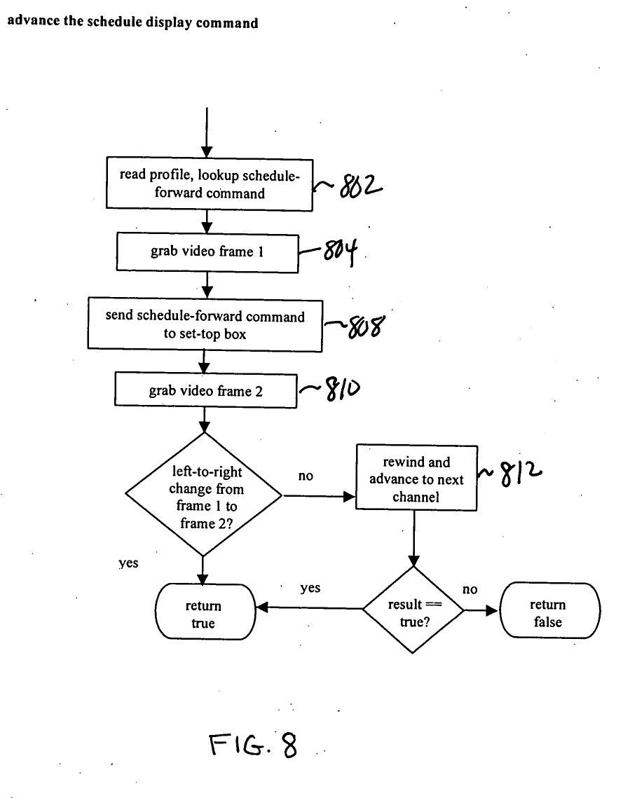

FIG. 8 shows a flowchart that describes the “Advance Schedule Display: command 616. The system 200 is coupled to a control program that runs the subroutine process, as described below. The printer 102 reads 802 the profile 300 and looks up the schedule forward command for the system 200. The printer 102 then grabs 804 a first video frame. The printer 102 sends 808 the schedule-forward command to the set-top box. Next, the printer 102 grabs 810 a second video frame. If there was no left-to-right change from frame one to frame two, then the printer 102 rewinds 812 and advances to the next channel. If there was a left-to-right change in content from frame 1 to frame 2, the printer 102 returns a true result to the control program that the schedule was advanced. Thus, the user continues to advance the displayed schedule time by making a left-to-right update of the schedule until there is no more data to display. For example, the user becomes aware of when the schedule is updated and there is no more future schedule information to update, when the user presses the right arrow on the remote and there are no further changes to the schedule.

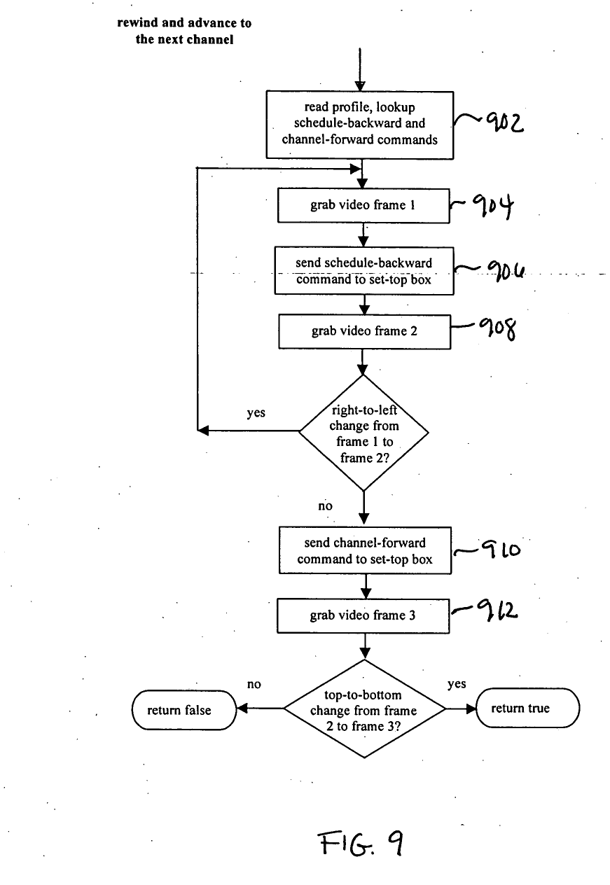

Referring now to FIG. 9, there is shown a flowchart describing an example of the “Rewind and Advance to the Next Channel” command 812. The system 200 is coupled to a control program that runs the subroutine process, as described below. The user enters and “Rewind and Advance to the Next Channel” command into the printer 102. The printer 102 reads 902 the profile, and looks up the schedule-backward and channel-forward commands. The printer 102 then grabs 904 a first video frame from the multimedia receiver 104. Next, the printer 102 sends 906 the schedule-backward command to the set-top box, and following that, the printer 102 grabs 908 a second video frame. If there was a right-to-left change in content from frame 1 to frame 2, the printer 102 then starts the process over again by grabbing 904 a first video frame. If there was no right-to-left change from frame 1 to frame 2, the printer 102 then sends 910 the channel-forward command to the set top box. The printer grabs 912 a third video frame and compares frames 2 and 3. If there was a top-to-bottom change from frame 2 to frame 3, the printer 102 returns a true response to the control program. If there was no top-to-bottom change or the channel number 406 at the bottom of the screen is less than the channel number above it, thus indicating that the display has cycled to the beginning of the channel list, the printer 102 returns a false response to the control program.

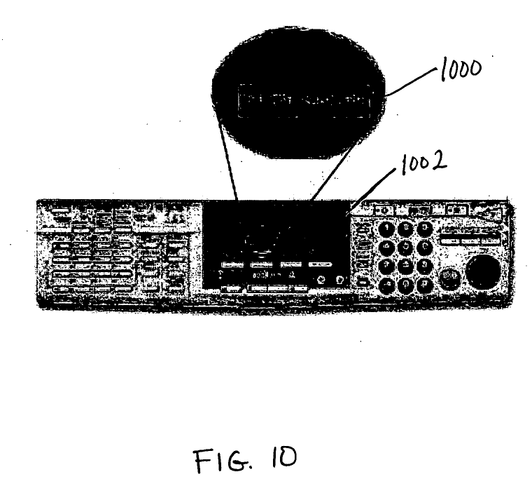

Referring now to FIG. 10, there is shown an embodiment of the present invention in which the printer 102 includes a print button 1000 displayed on a printer display 1002. In the example depicted in FIG. 10, the print button 1000 is shown as a “PrintTV Schedule” box on the printer display 1002. The user prints a schedule by selecting the print button 1000 on printer 102. For example, the print button 1000 might be included on a printer touchscreen that the user selects by touching the print button 1000 on the screen. As another example, the print button 1000 might be included on a printer keypad, and the user presses the print button 1000 on the keypad to request a printed schedule

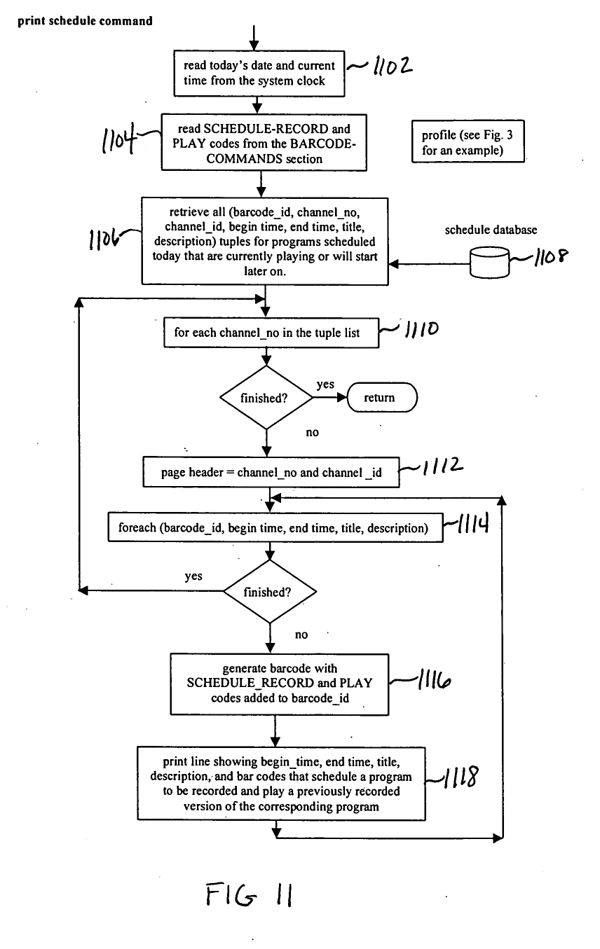

FIG. 11 shows a flowchart that describes the “PrintTV Schedule” command. The user enters a “PrintTV Schedule” command into the printer 102. The printer 102 responds by reading 1102 today's date and current time from the system clock. The printer 102 reads 1104 the SCHEDULE-RECORD and PLAY codes from the BARCODE-COMMANDS section of a profile. FIG. 3, discussed previously, shows an example of such a profile. The printer 102 retrieves 1106 all information for the programs scheduled today that are currently playing or will play later in the day. The information retrieved 1106 by the printer 102 includes barcode ID, channel number, channel ID (e.g., program title or type), begin time, end time, title, description, and the like. This information is retrieved from the schedule database 1108. The printer 102 checks each channel number in the information list 1110. If the program being shown on the channel has already finished, the printer 102 returns to checking another channel in the information list. If the program being shown on the channel has not finished, the printer 102 creates a page header 1112 for the schedule, and the header includes the channel number and channel ID. The printer 102 also adds other information to the schedule for the channel number 1112, including barcode ID, begin time, end time, title, description, and the like. If the printer 102 has not yet finished preparing the schedule for all channel numbers requested by the user to be included in the document, the printer 102 returns to selecting another channel number in the information list until all schedule information for all channels is included in the document. The printer 102 then generates 1116 a barcode with SCHEDULE_RECORD and PLAY codes added to the barcode ID, and these barcodes can be generated for each program included in the schedule. The printer 102 prints 1118 for each program a line showing the begin time, end time, title, description, and barcodes that schedule a program to be recorded and to play a previously recorded version of the corresponding program. After the barcodes are added to the document for one channel, the printer then returns to generating and printing barcodes for the next channel to be included in the schedule.

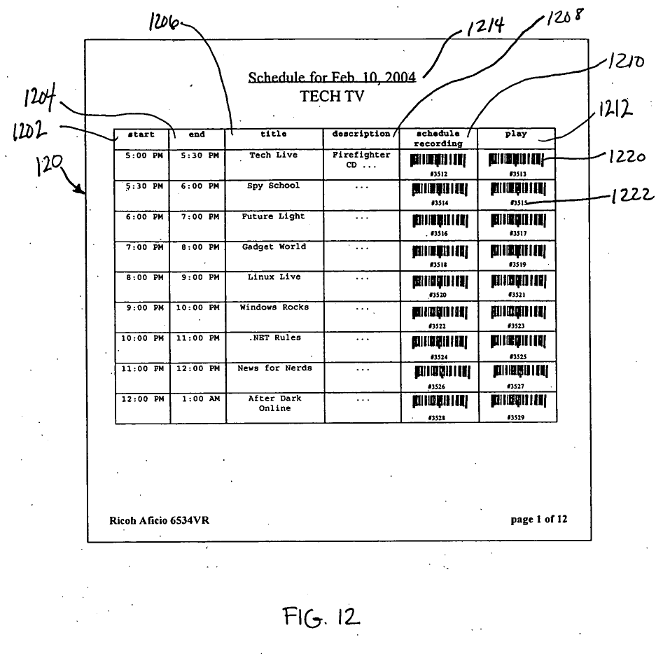

Referring now to FIG. 12, there is shown an embodiment of a multimedia document 120 that can be produced by the printer 102. The multimedia document 120, in this example, is a schedule document showing the schedule of programs to be broadcast on the TECH TV network for Feb. 10, 2004. The multimedia document 120 includes a document header 1214 that includes the network name and the schedule date information. The multimedia document 120 further includes a number of columns, each containing information about TECH TV programs. In this example, there is shown a start time column 1202 and an end time column 1204, displaying the start and end times of each program. In the FIG. 12 example, there is also shown a title column 1206 showing the title of each program broadcast on TECH TV for February 10. Additionally, the example includes a description column 1208 that provides some type of description or summary of each of the programs. The FIG. 12 example also includes a schedule recording column 1210 and a play column 1212. In both the schedule recording column 1210 and the play column 1212, there is shown a barcode 1220 for each program. The user can scan a barcode 1220 under the schedule recording column 1210 for a particular program to command the printer 102 to schedule recording of the program when it is broadcast. The user can also scan a barcode 1220 in the play column 1212 of a particular program. The program will play if this program was previously recorded and is stored in the printer 102, or if the program is otherwise available or accessible to the printer 102. In both the schedule recording column 1210 and the play column 1212, there is shown a numerical identifier 1222 for each program. As an alternative to scanning the barcodes 1220 to schedule the recording of a program or to play a program, the user can type in the numbers shown in the numerical identifier 1222 for a particular program. Entering in the numerical identifiers 1222 in the schedule recording column 1210 causes a program to be recorded, while entering in the numerical identifiers 1222 in the play column 1212 causes the program to be played.

While the present invention has been described with reference to certain preferred embodiments, those skilled in the art will recognize that various modifications may be provided. Variations upon and modifications to the preferred embodiments are provided for by the present invention, which is limited only by the following claims.

What is claimed is:

1. A system for recording media content and for generating media representations, the system comprising:
an extraction module for extracting of media content from a media receiver;
an output device for generating a media representation of media content extracted from the media receiver, the output device being coupled to the extraction module; and
a media transfer interface for permitting communication between the output device and the media receiver, the media transfer interface being coupled to the media receiver.

2. The system of claim 1, further comprising media content recognition software for recognizing features in media content.

3. The system of claim 2, wherein the media content recognition software further comprises speech recognition software.

4. The system of claim 2, wherein the media content recognition software further comprises optical character recognition software.

5. The system of claim 2, wherein the media content recognition software further comprises face detection software.

6. The system of claim 2, wherein the media content recognition software further comprises speaker detection software.

7. The system of claim 2, wherein the media content recognition software further comprises keyframe selection software.

8. The system of claim 2, wherein the media content recognition software further comprises face recognition software.

9. The system of claim 1, further comprising processing logic for controlling display of a user interface, wherein the user interface permits the user to control actions of the output device.

10. The system of claim 1, further comprising processing logic for controlling the generation of a media representation.

11. The system of claim 1, further comprising a storage medium for storing media representations in electronic format.

12. The system of claim 1, wherein the media representation generated by the output device is stored on a digital storage medium.

13. The system of claim 1, further comprising one or more user interaction devices that permit the user to interact with the printer and control the printer's actions, wherein the user interaction devices are external to the printer.

14. The system of claim 1, wherein the media representation is generated in paper format that includes at least one user-selectable identifier allowing a user to access and control media content.

15. The system of claim 14, wherein the at least one user-selectable identifier comprises at least one barcode printed on the media representation.

16. The system of claim 15, wherein the at least one barcode further comprises at least one record barcode that can be scanned to record an associated media program.

17. The system of claim 15, wherein the at least one barcode further comprises at least play barcode that can be scanned to play an associated media program.

18. The system of claim 14, wherein the at least one user-selectable identifier comprises at least one numerical identifier which the user can type into an external device to access and control media content.

19. The system of claim 1, wherein the media representation is a document displaying scheduling information for media programs.

20. A method for recording media content and for generating media representations, the method comprising:
extracting media content from a media receiver;
generating a media representation of the media content; and
communicating with a media receiver through a media transfer interface, wherein an output device communicates with the media receiver.

21. The method of claim 20, further comprising the output device using media content recognition techniques to recognize media content extracted from the media receiver.

22. The method of claim 20, further comprising the output device sending commands to the media receiver to control actions of the media receiver.

23. The method of claim 20, further comprising scheduling actions of the media receiver to occur at predefined times.

24. The method of claim 23, wherein scheduling actions further comprises scheduling generation of a media representation, wherein the generation is scheduled to occur at user-defined time periods.

25. The method of claim 24, wherein scheduling generation of a media representation further comprises entering scheduling preferences into a profile that controls actions of the output device which controls actions of the media receiver.

26. The method of claim 20, wherein generating a media representation further comprises generating a schedule representation of a list of media programs, wherein the schedule representation includes specific information about each media program.

27. The method of claim 26, wherein generating a schedule representation of a list of media programs further comprises formatting the schedule representation based on a pre-defined user preferences profile.

28. The method of claim 26, wherein generating a schedule representation of a list of media programs further comprises updating the generated schedule representation to include current schedule information.

29. The method of claim 26, wherein generating a schedule representation of a list of media programs further comprises:
setting a media display to a channel that includes a schedule display showing media program scheduling information; and
performing optical character recognition on the schedule display of the media display to read schedule information content and generate a representation of the schedule display.

30. The method of claim 26, wherein generating a schedule representation of a list of media programs further comprises searching for specific user-defined features within the media content and displaying search results.

31. The method of claim 20, further comprising monitoring commands from an external interface, wherein the commands include a request to generate a media program schedule representation with user-defined parameters.

32. The method of claim 20, further comprising monitoring commands from an external device, wherein the commands include a request to update an internal table that stores the association between user-selectable identifiers printed on the media representation and the actions that can be executed on the output device in response to those user-selectable identifiers.

33. The method of claim 20, further comprising recording media content and storing the media content on a storage medium, wherein the stored media content can be played in response to commands received from an external device interface.

34. The method of claim 20, further comprising a web server with a common gateway interface for controlling the schedule for recording and playing of media content.

35. The method of claim 20 wherein generating a media representation further comprises printing media schedule information in a paper-based format.

36. The method of claim 35, further comprising selecting a user-selectable identifier on the paper-based format of the media schedule information to record the associated media program.

37. The method of claim 35, further comprising selecting a user-selectable identifier on the paper-based format of the media schedule information to play the associated media program.

38. The method of claim 26, further comprising updating a database that stores current schedule information and associated user-selectable identifier information.

39. The method of claim 26, further comprising advancing a schedule display, wherein advancing the schedule display comprises:
capturing a first frame of the current schedule display on a schedule channel;
sending a command to the media receiver to advance the schedule display on the schedule channel;
capturing a second frame of the advanced schedule display on the schedule channel; and
comparing the first frame to the second frame to determine if the schedule has changed and the schedule display should be advanced.
